(19) United States
(12) Patent Application Publication
(10) Pub. No.: US 2026/0267368 A1
(43) Pub. Date: Sep. 10, 2026

(54) JOYSTICK

(71) Applicant: Scorpion Joystick Ltd., Swansea (GB)

(72) Inventors: Roger John, Llanelli (GB); James Dexter, Monmouthshire (GB)

(21) Appl. No.: 18/871,853

(22) PCT Filed: Jun. 13, 2023
(86) PCT No.: PCT/GB2023/051528

§ 371 Date: Dec. 5, 2024

(30) Foreign Application Priority Data
Jun. 17, 2022 (GB) 2208912.2
Jul. 8, 2022 (GB) 2210041.6
Apr. 25, 2023 (GB) 2306081.7

(51) Int. Cl. G05G 9/047

(52) U.S. Cl. CPC G05G 9/047; G05G 2009/04711

(57) ABSTRACT

The present invention relates to a joystick. The joystick comprises a lever mounted to a base by a pivot, the base having one or more position sensors for sensing a position of the lever relative to the base, the lever having a longitudinal length extending between the pivot and a distal end. An input shaft is pivotally mounted to a support, the input shaft having a longitudinal length extending between a first end having an input portion for receiving a user input and a second end, the second end cooperating with the distal end of the lever such that pivoting of the input shaft relative to the support causes pivoting of the lever relative to the base.

### CROSS-REFERENCE TO RELATED APPLICATIONS

This application is a U.S. National Phase of International Patent Application No. PCT/GB2023/051528, entitled “JOYSTICK”, filed on Jun. 13, 2023, which claims priority to GB Patent Application No. 2208912.2, filed Jun. 17, 2022; GB Patent Application No. 2210041.6, filed Jul. 8, 2022; and GB Patent Application No. 2306081.7, filed Apr. 25, 2023, the entire contents of each which are incorporated herein by reference in their entirety.

### TECHNICAL FIELD

The present invention relates to a joystick.

Analogue and digital joysticks are used in arcade machines, computers and consoles with certain games requiring the high accuracy of analogue and others operating with the simpler digital form of control.

A digital joystick using the 4 standard microswitches only has 8 possible positions available depending on which microswitches are activated by the direction the joystick lever is pushed in. Therefore, a digital joystick has an OFF-ON setting of one of 8 positions in total. It is either OFF or ON at one of the positions from North to North around a circumference with the diameter set by the joystick housing. Accordingly, subtilities in intended input direction by a user cannot be identified, as eight directions can only be identified. A benefit however of a digital joystick is that the throw or angle of the input shaft relative to the vertical can be small such as 10 degrees meaning activation is fast.

An analogue joystick has a possible 360 positions around the circumference of the joystick housing when fully activated but also numerous positions between the inside of the effective circle. The major problem with analogue joysticks over digital is the angle they use to be activated. Due to the nature of the variable potentiometers used to set the position of the analogue joystick, the angle or throw of the lever is dramatically increased when compared to digital joysticks. This increased angle does not find favour with people used to the more acute angle of a digital joystick and they are considered too slow to activate effectively in comparison.

Some analogue joysticks can be made to act in a digital manner by using software on the device being controlled which interprets the analogue resistance and produces a corresponding digital signal based on preset parameters. However, joysticks that effectively convert analogue signals to digital can suffer from some lag due to the extra programming time to perform that conversion. This latency can be a serious limitation to this form of game control.

Although an analogue controller technically has an almost unlimited number of positions, the A to D conversion usually converts this to a digital value of between −32768 and 32767 (depending upon the resolution of the conversion) and to achieve an XY position both potentiometers produce a voltage using Ohms Law of V=IR at the time the voltage is read by the host computer. The voltage is proportional by varying the resistance using the throw of the joystick lever.

Other methods of reading an XY position include Hall Effect sensors, but the theory is the same and the same issues of throw angle are relevant to any type of analogue joystick.

There are single analogue joysticks available but these are unpopular for the same reasons and efforts have been to reduce the throw of their lever with limited success.

Aspects of the present invention aim to address deficiencies identified above, or at least provide a useful alternative.

According to the present invention there is a joystick comprising:
a lever mounted to a base by a pivot, the base having one or more position sensors for sensing a position of the lever relative to the base, the lever having a longitudinal length extending between the pivot and a distal end;
an input shaft pivotally mounted to a support, the input shaft having a longitudinal length extending between a first end having an input portion for receiving a user input and a second end, the second end cooperating with the distal end of the lever such that pivoting of the input shaft relative to the support causes pivoting of the lever relative to the base.

The present invention enables a reduction in the angle to the vertical at which a usable signal can be measured (angle or throw of the input shaft) as well as being able to measure a signal around the entirety of the circumference.

It will be appreciated that the lever is biased from a rest to a displaced configuration whereby the one or more position sensors sense a displaced position of the lever relative to the base through the biasing of the input shaft from a rest configuration to a displaced configuration. Thus, the input shaft is beneficially displaceable from a rest to a displaced configuration. The lever is also displaced from a rest to a displaced configuration by virtue of cooperation with the input shaft.

The longitudinal length of the input shaft is beneficially greater than the longitudinal length of the lever. The length difference can be varied to modify the angle or throw of the input shaft as required (typically a suitable throw is 10 degrees from vertical).

The input shaft beneficially pivots relative to the support at a position vertically above the pivot about which the lever pivots relative to the base. It will be appreciated that the support and the base remain stationary in use.

Movement of the input shaft in a first direction results in movement of the lever in a second opposing direction. Accordingly, the one or more position sensor outputs are indicative of movement of the input shaft in an opposite direction to that sensed.

The pivot beneficially allows pivoting in a pivot plane about multiple pivot axes. The pivot is preferably at least partially spherical.

One of the distal end and second end of the lever and input shaft respectively preferably receives the other of the distal end and second end into a receiving zone therein.

The receiving zone projects lengthwise into the input shaft or lever, and the distal end or second end is moveable longitudinally through the receiving zone. This means that either the distal end or second end is not fixed longitudinally in the shaft, and some longitudinal movement is accommodated towards maximum displacement of the input shaft. Either the distal end or second end comprises at least a partial sphere. The receiving zone preferably comprises a width arranged to receive the sphere such that the sphere contacts opposite sides of the receiving zone. The diameter of the sphere and width are substantially the same. The distal end of the primary shaft is preferably received into the receiving zone in the second end of the secondary shaft.

The one or more position sensors preferably measure an analogue output. The one or more positions sensors preferably comprise variable potentiometers, however numerous known alternatives are envisaged such as cameras, laser positioning (such as used in a mouse IC) or others.

In some embodiments it may also be beneficial to provide both an analogue and a digital output from the joystick. A plurality of switches are beneficially provided such that as the input shaft is biased from a rest position to a displaced position, the input shaft engages with at least one of the plurality of switches to effect activation of at least one of the plurality of switches. The plurality of switches are beneficially disposed intermediate the support and the input shaft. This is to provide an output representative of the position of the input shaft relative to the support. The joystick can therefore also provide a digital output. The joystick is preferably operable to provide a digital and/or an analogue output. This can be selected dependent upon the joystick use. For example, for some games digital outputs are preferred, whereas for other games analogue outputs are preferred. An actuator is preferably provided carried by the input shaft for activating switches carried by the support.

The input shaft may comprise a flange projecting transversely/outwardly from the longitudinal length of the input shaft for activation of the plurality of switches. The plurality of switches are beneficially each disposed around the input shaft. This means that as the input shaft and thus flange is tilted outside of a vertical axis the flange contacts with one or more respective sensors thus providing an output signal. There is preferably activation of the switches vertically. As an example, eight sensors may be disposed around the input shaft. The input shaft preferably extends through the support. The input shaft and support preferably cooperate by a ball and socket joint. The flange may project from the ball.

The one or more position sensors beneficially sense displacement of the lever relative to the base from a rest position to a displaced position, the joystick further comprising a biasing arrangement for biasing the input shaft toward a position for retaining the lever in the rest position.

The biasing arrangement is preferably arranged to bias the input shaft toward a position whereby the input shaft and lever are axially aligned. The perceived resilience or ‘feel’ of the biasing arrangement will differ greatly as the input shaft is articulated from a normal rest position with the lever and input shaft aligned, to a subsequent lateral deflection, depending on the biasing arrangement utilised. A typical known arrangement in a traditional joystick is a constant diameter spring held between two opposing plates. Deflection of the input shaft therefore causes compression of the spring portion to oppose that movement. To move the input shaft in such a configuration from the rest position will require a force commonly known as ‘lift off’. This results from residual pre-tensioning of the spring acting about two flat surfaces. Accordingly, the biasing arrangement preferably comprises a conical spring. The diameter of the turns of the conical spring increases from a first end to a second end. The diameter of the conical spring beneficially increases in the first direction from the second end towards the first end. The biasing arrangement is preferably carried by a housing, and the housing is releasable mountable relative to the input shaft.

The provision of a conical (which may also be termed ‘involute’) spring self-centres the input shaft that when at rest the input shaft always adopts a vertical position (relative to the housing). Applying a lateral force to the input shaft causes pitching from the vertical axis. Being a centre tensioned spring, the input shaft freely moves, proportionally to the load applied purely against the spring force; without any hysteresis as would be generated in partial compression of a constant diameter spring against flat surfaces.

The biasing arrangement may alternatively comprise an elastomeric bushing. An elastomeric bushing suffers few of the above problems having a zero force start position, without the lift off effect, when moving from a vertical axis but has an entirely different ‘feel’ that is not acceptable by certain groups of players. Such an elastomeric bushing both twists and compresses when a radial force is applied about the mid-point. In turn this creates both drag and exponential pressure proportional to the distance of travel. The line of force is beneficially linear and the resultant will be singular in the direction of tension in the elastomeric bushing.

The joystick may be modified in accordance with a player's unique preferences in a manner known as ‘plug and play’; where elements controlling the resilient forces of the joystick input shaft may be adapted to provide a greater or lesser resistance to movement, thereby adapting the ‘feel’ in the articulation of the input shaft. Primarily the ‘feel’ is subjective and will vary from player to player Some users favour a joystick input shaft acting on a metal spring whereas other players favour the feel of a resilient elastomer. For this reason, it is beneficial that the biasing arrangement can be replaced with an alternative version depending on a user's specific requirements. Accordingly, the joystick preferably comprises a first and second housing portion, where the first and second housing portion are releasably mountable to one another and cooperate to define a receiving zone for the biasing arrangement. The biasing arrangement is preferably releasably mountable in the receiving zone.

### BRIEF DESCRIPTION OF THE DRAWINGS

Aspects of the invention will now be described by way of example only with reference to the accompany drawings where:

FIG. 1 is a cross sectional partial representation of an illustrative embodiment of the present invention.

FIG. 2 is a perspective cross-sectional representation of an illustrative embodiment of the present invention with the input shaft in an upright or non-displaced configuration.

FIG. 3 is a perspective cross-sectional representation of an illustrative embodiment of the present invention with the input shaft in a displaced configuration.

FIG. 4 is a schematic cross-sectional representation of an illustrative embodiment of the present invention with the input shaft in a displaced configuration.

FIG. 5 is a perspective cross-sectional representation of an illustrative embodiment of the present invention with the input shaft in a displaced configuration.

FIG. 6 is an isometric representation of an illustrative embodiment of the present invention.

FIG. 7 is a perspective exploded and side view representations of a part of an illustrative embodiment of the present invention.

FIG. 8a is a perspective exploded and side view representations of a part of an illustrative embodiment of the present invention and FIG. 8b shows the same part integrated into an illustrative embodiment of the present invention.

FIG. 9a is a perspective exploded and side view representations of a part of an illustrative embodiment of the present invention and FIG. 9b shows the same part integrated into an illustrative embodiment of the present invention.

FIG. 10a is a perspective exploded and side view representations of a part of an illustrative embodiment of the present invention and FIG. 10b shows the same part integrated into an illustrative embodiment of the present invention.

### SUMMARY OF THE INVENTION

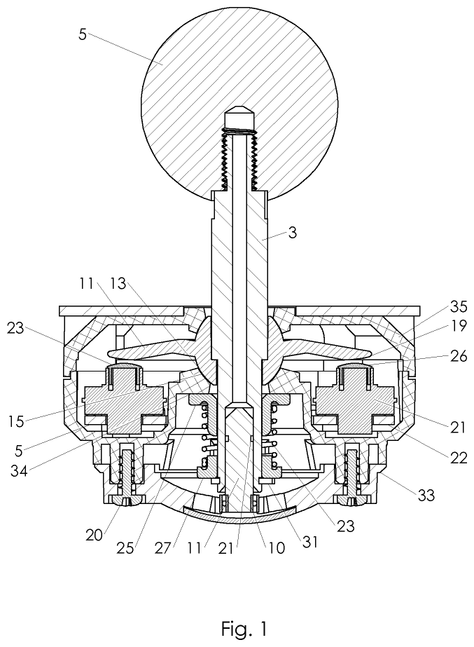

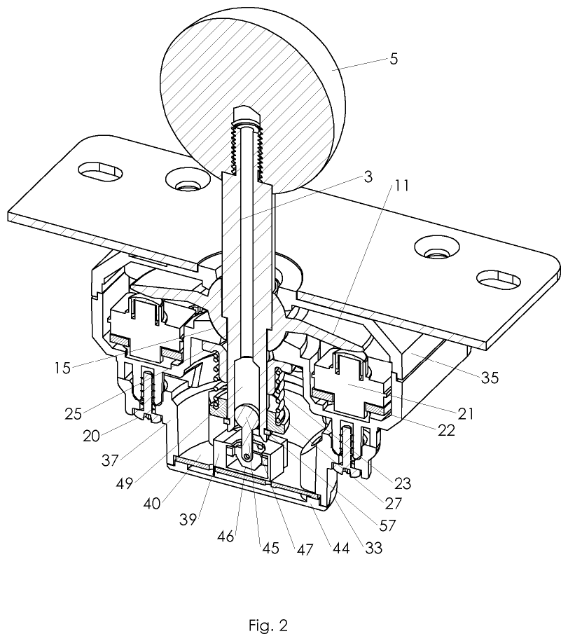

FIG. 1 is a schematic representation of a partial representation of an illustrative embodiment showing only digital input utilising a digital switch, 4 way (NESW) and 8 way (N. NE. E. SE. etc.). The joystick arrangement comprises a base structure 1 and a joystick input shaft 3 capable of pivoting in all directions relative to the base moulding 1. The degree of movement may be plus or minus ten degrees. A hand control knob 5 is located at a first end of the input shaft 3 and is shaped to receive a user's hand and receive a user input and is arranged to afford a comfortable, firm hand grip. Motion of the input shaft 3 is limited, partly for accuracy in hand movement response and a limited hand travel distance being like the radial motion of the wrist. Typically, the input shaft 3 is limited to an arc of travel in both the ‘X’ axis and ‘Y’ axis of about ten degrees, this being the preferred angle for comfortable and fast control of movement in video games. The input shaft 3 extends to an opposing second end 7 for cooperating with a lever 9 shown in subsequent figures. Extending outwardly from the input shaft 3 intermediate the first and second ends is a structure 11 capable of enabling the input shaft 3 to pivot relative to the base structure 1. In the embodiment presented this structure 11 comprises a partial spherical contact surface 13 that enables pivoting relative to a corresponding socket 15 in the base structure 1. Thus, free motion in all radial directions about the vertical axis is afforded.

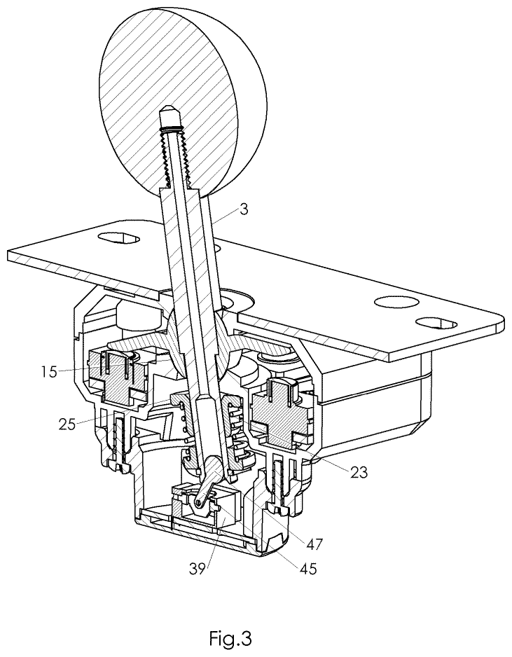

Projecting outwardly from the structure 11 is a flange 17 which can be termed a ‘striker’ which is fixed to the input shaft 3. This flange may extend around the entire periphery of the input shaft 3 and comprises an actuation surface 19 for actuating the plurality of digital switches 21. As presented in FIG. 1 there are two such switches visible. Reference will be subsequently made to FIGS. 3-5 which show the input shaft 3 in the deflected position thereby activating a digital switch 21. The joystick arrangement as presented incorporates four switches 21 so arranged in N.E.S.W. configuration, each spaced at 90 degrees to each other on a printed circuit board 22. The switches are of the plunger type, working in line to the central axis of the joy-stick assembly. To minimise friction and irregular contact surfaces a dome 9 is added to the top of the switch. In operation the hand control knob is deflected sideways thereby causing deflection of the input shaft 3 and the structure 11 thus causing actuation of the switches 21. The actuation surface exhibits a flat surface such when the switch plunger (forming part of the switch) has been depressed to the point of changeover from open to closed, the flat surface is horizontal to minimize lateral forces affecting a clean electrical switchover.

The input shaft 3 then passes through an aperture in the base moulding 1. It is important that the input shaft 3 moves back to an upright/vertical position as shown in FIG. 1 when force is removed. To achieve this functionality a biasing arrangement 23 is utilised that in the illustrative embodiment is a spring that bears against a collar 25 which is slidably mounted relative to the input shaft 3. The spring is carried by a spring retainer 27. The spring bears against the collar and pushes the collar 25 against a contact surface 29 which may comprise a plate secured to the base structure 1. As the input shaft 3 is deflected the collar bears against the plate 29 deflecting the spring and biasing the input shaft back towards the vertical position. Upon release of the hand control knob 5 there is movement back towards the vertical position. A retaining clip (such as a ‘C’ clip) 31 is provided to retain the spring retainer 27. The spring retainer 27 also has the facility to protect from excessive forces acting on the internal components, such that when the input shaft 3 has been deflected strikes the internal radial surface of the base structure and will absorb any excess force.

As shown in the embodiment presented, a lower housing 33 is fixed by multiple screws 35 to the base structure 1. The internal configuration of the lower housing can be designed to accommodate various configurations as will be apparent from subsequent illustrative embodiments. An upper structure 35 is also provided fixed to the base structure 1.

Referring now to FIG. 2, an illustrative embodiment of the present invention shows the same components as described with respect to FIG. 1. However, in this illustrative embodiment there is the provision of a lever 45 present to allow an analogue output with reduced throw of the input shaft 3. It will be appreciated that in according to the claimed invention the provision of the digital switching is an optional feature. Accordingly, the embodiment of FIG. 2 also incorporates a digital output as described with respect to FIG. 1 which can be used if required for some applications to provide the benefit of selective or joint digital and analogue outputs.

Referring to FIG. 2, an analogue switching module 37 is provided comprising a lower housing 33 which houses as an example a multi-axis (such as a two-axis) potentiometer 39 and a multi way connector 41 (shown in FIG. 3) assembled on a printed circuit board 43. The circuit board 43 is held securely in place such the multi axis potentiometer is held concentric to the center-line of the input shaft 3. Extending from the potentiometer which forms a base is a lever 45. The lever 45 articulates by a multi axis gimbal assembly 46 allowing movement through as an example thirty degrees relative to the vertical axis. The opposing distal end of the lever 45 comprises a partially spherical element 47. This element 47 is received into a shaft 49 in the second end of the input shaft 3 extending longitudinally through the input shaft 3. The relative diameter of the element 47 and shaft is a clearance fit, allowing the element 47 to enter the shaft 49 and move longitudinally up and down the shaft 49 as the input shaft 3 is articulated as will be described with respect to FIG. 3 in more detail.

An advantage in this arrangement is to provide a continuity of motion from the input shaft 3 which may pitch and rotate about the common linear axis and transmit the identical motion, albeit in a mirror image, to the lever 45 forming part of the multi axis potentiometer 39. By employing a partially spherical element where the spherical portion abuts the wall defining the shaft 49, displacement is accommodated, firstly as a result of the diminishing angles as the lever 45 drives the element 47, to and from the vertical axis. Likewise, being an isotropic sphere, irrespective of the linear position and angle, the spherical nature will always occupy an identical relationship to the parallel inner wall defining the shaft.

It will be appreciated that the longitudinal length of the lever 45 is less than the longitudinal length of the input shaft 3. This is to ensure that the throw of the input shaft 3 is reduced and can be made like that of a known digital joystick.

Further referring to FIGS. 2, 3, 4 and 5, the joystick has two separate outputs via electrical connectors. These separate outputs are digital and analogue and can be transmitted simultaneously for further processing.

A more detailed view detailing the relationship of the lever 45 in the form of a potentiometer shaft with element 47 positioned in the lower end of the lever 45 is shown in FIGS. 3-5 with the input shaft 3 in a tilted position. In the rest position the spring 23, acting on the collar 25, vertically aligns both the input shaft 3 and lever 45. In the tilted position, when the input shaft 3 is moved from the vertical or rest position, the element 47 forming the top end feature of the lever 45 moves to position proportional to the angular displacement of the input shaft 3. This relationship is important when integrating components, each of which their own characteristics of motion. A typical example is a for a multi axis potentiometer 39 where the lever 45 has differing angles in pitch about the vertical centerline resulting in a variation in full scale deflection of the potentiometric values. Similar components may be limited in their radial motion or even height about the center of rotation. While being a very complex consideration, these problems can be overcome in considering the free lengths of the input shaft 3 and the lever 45, where increasing the length of the distance from the center of rotation of the input shaft 3 will result in a greater swept distance and conversely to shorten the distance will have the opposite effect and truncate the motion. The angle of displacement of the shaft 3 will remain the same.

The same will apply for the multi axis potentiometer 39 and specifically the lever 45. In many cases due to the specification and manufacturing process, restrictive motion may be demanded to eliminate the eventuality in applying excessive forces generated from a longer input shaft 3. Typically, the amplitude of motion from the input shaft 3 to the lever 45 has a ratio of 1:3. Simply in changing the relative distances between the fulcrum point of the joystick (at the spherical surface 15) to the point of contact of the element 47 will result in an increase or decrease in the angular motion of the lever.

A further embodiment in this arrangement is the apparent diameter of the element 47, cut about the center point, will result in the cut face always being circular irrespective of the angle of cut. Hence when a ball sphere 47 is inserted in the hollow form at the end of the input shaft 3, the sphere diameter will always occupy the entire cross sectional diameter of the shaft 49. As the element 47 is fixed to the lever 45 which in turn is fixed to the potentiometer 39 at a constant length, the element 47 moves linearly along the longitudinal length of the shaft 49.

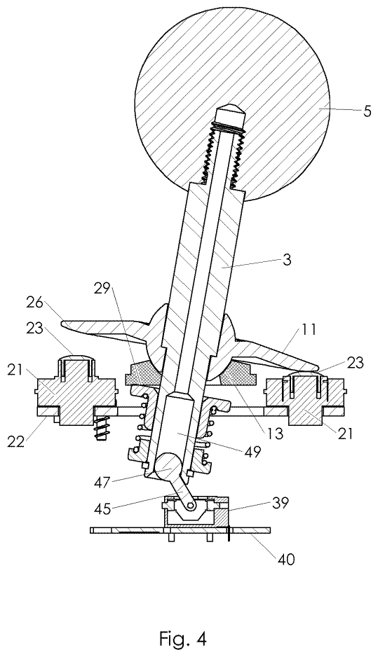

Referring now to FIG. 4, action of the digital input (represented by zone 61) and analogue input (represented by zone 63) is shown where the joystick housing has been removed for clarity purposes. The structure 11 is tilted by action of an input on the input shaft 3 causing actuation of a switch 21. The actuation surface 19 of the structure 11 depresses the switch plunger downwardly to the point of changeover from open to closed. It will be appreciated that the Figures are presented in either cross section or two dimensions, therefore additional switches 21 are disposed around the structure 11. At the same time the collar 25 bears against the contact surface 29 and pushes against the spring 23 meaning release of the input shaft allows the input shaft to revert to an upright vertical rest configuration.

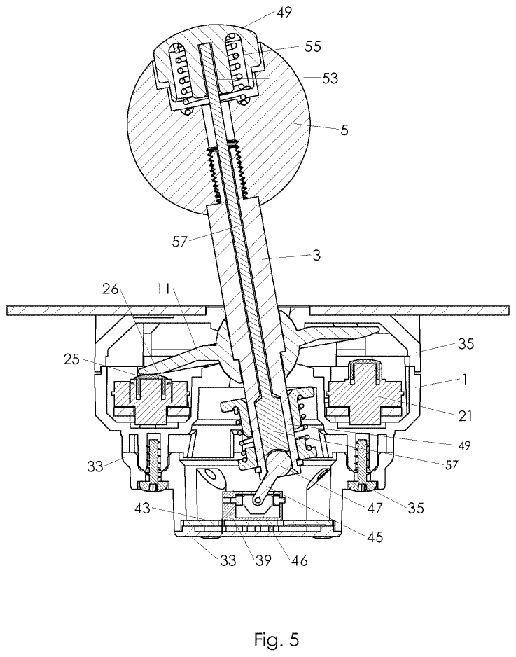

The embodiment as described also allows what is known as a fire button 49 as presented in FIG. 5. This fire button 49 is disposed on top of the hand control knob 5. Application of pressure on the fire button 49 will transmit the force through the retaining screw 53 against the spring 55 which in turn pushes shaft 57 downwardly which then bears against the element 47 and finally activates an electrical switch within the body of the multi axis potentiometer 39. Also shown in FIG. 5 is the lower housing 33 secured to the upper housing 1 by screws 35. As described in detail elsewhere, these can be removed to enable access into the housing as a whole for replacement or customization of the biasing arrangement 23.

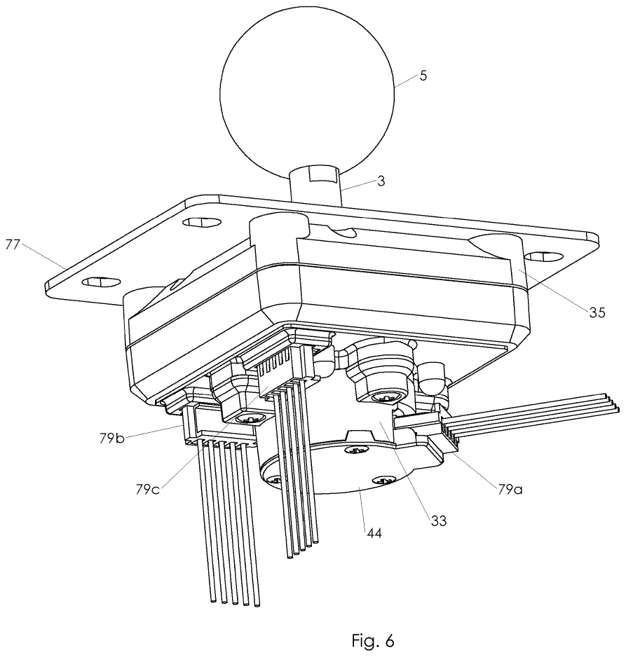

Referring to FIG. 6, presented is an isometric representation of a joystick arrangement according to an illustrative embodiment of the present invention showing the base structure 1 housing the various components, upper structure 35 secured to the base structure 1, and lower cover 33. The input shaft 3 extends upwardly from the upper structure 35. There is a fixing plate 77 for fixing to a support and external wiring looms 79 for transmission of the signals from the analogue and/or digital inputs. In the embodiment presented there is analogue connector 79a, first digital connector 79b and second digital connector 79c for reverse polarity.

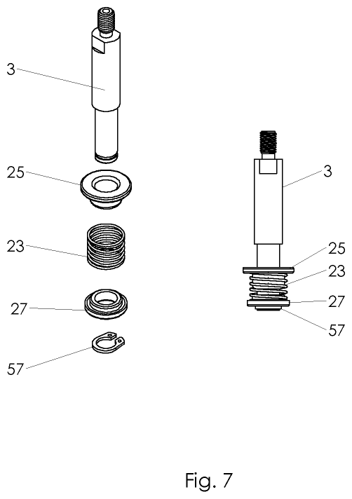

As described with respect to FIGS. 1-5, a biasing arrangement 23 is utilised to ensure the input shaft 3 reverts to a vertical orientation once a force is removed. As described, this functionality is achieved in FIGS. 1-5 through the provision of a spring that bears against a collar 25 which is slidably mounted relative to the input shaft 3. The spring bears against the collar and pushes the collar 25 against a contact surface 29 which may comprise a plate secured to the base structure 1. As the input shaft 3 is deflected the collar bears against the plate 29 deflecting the spring and biasing the input shaft back towards the vertical position. Upon release of the hand control knob 5 there is movement back towards the vertical position. Referring now to FIGS. 7-10, FIG. 7 represents the biasing arrangement in exploded view and assembled view with the input shaft 3 for the embodiments as presented in FIGS. 1-5, and FIGS. 8 and 9 are illustrative embodiment of alternative biasing arrangement configurations.

Referring to FIG. 7, shown is the collar 25 that slidably engages with the outer surface of the input shaft 3. This collar 25 bears against the spring 23, where the spring also bears against the spring retainer 27. The assembly is held on the input shaft 3 by circlip 57. This approach of a sliding collar bearing against the spring as the input shaft is tilted off vertical functions, however some users of the joystick, particular in gaming applications, prefer a lighter and more easily flowing motion of a ‘spring to centre’ input shaft 3, or even a stiffer return to centre action. To accommodate these preferences, springs 23 of various compression spring rates and loadings are available.

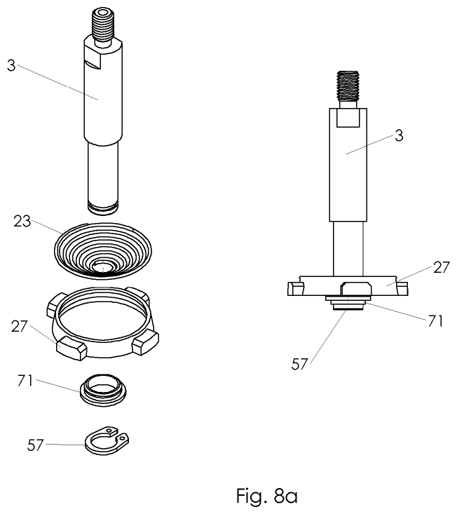

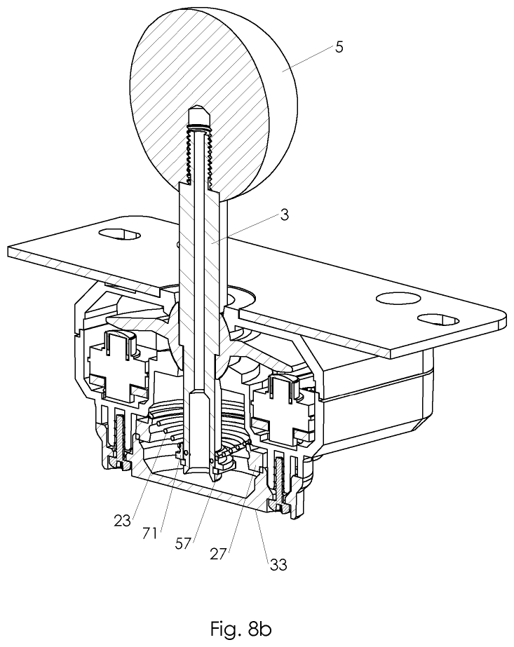

An alternative configuration is presented in FIG. 8a (exploded view and assembled view respectively) where the biasing arrangement comprises a conical spring 23 for modifying the feel of the joystick. FIG. 8b shows the conical spring 23 in an operational configuration in the joystick. Spring retainer 27 is provided for receiving and carrying the spring 23 and can be slotted into the upper housing when the analogue input portion is removed. A sleeve 71 is provided that extends over the input shaft 7 held by a circlip 57 providing support to the lowermost portion of the spring 23. It will be appreciated that the smallest diameter turns of the conical spring are at the lower end and the wider turns at the upper end in the joystick assembly. The upper turn of the spring is retained in a fixed position in the housing, meaning that in comparison to the embodiment of FIG. 8, there is no moveable collar and no movement of the upper turn. Instead, tilting of the input shaft 3 causes the lower end of the input shaft to bear against the lower end of the conical spring. It is further beneficial that the slope angle of the conical section lies on a similar radius as the distance from the centre point in motion. Accordingly, such a conical spring 23 produces a clean travel and response in motion in any direction, without any hysteresis in force throughout the entire field of movement. It will be appreciated for clarity purposes that the analogue switching arrangement has not been presented in FIG. 8b and a lower housing in the form of a cover 33 is schematically represented.

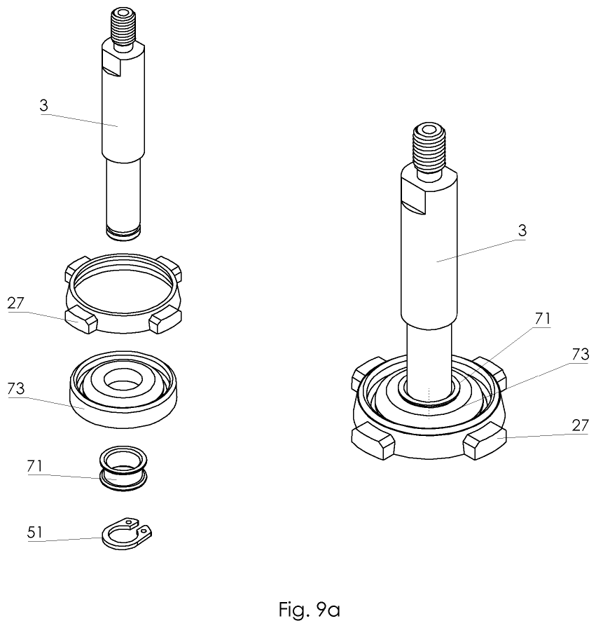

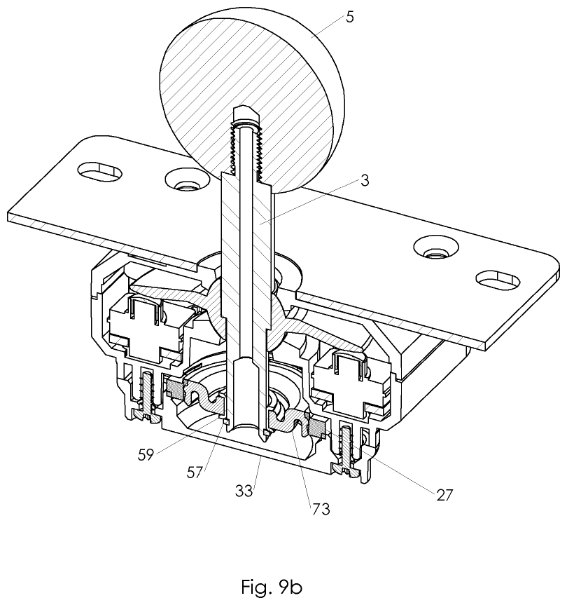

An alternative configuration as presented in FIG. 9a (exploded view and assembled view respectively) where the biasing arrangement comprises an elastomer for modifying the feel of the joystick. FIG. 9b shows the elastomer 73 in an operational configuration in the joystick which acts as a bush and is commonly referred to as a grommet. Such elastomers produce a similar feel as the joystick lever transitions, from one full scale to a full scale in the opposite direction. When released the joystick lever will return to a neutral or vertical position. The resilience of this motion can be regulated in the choice of hardness of the elastomer, thickness and reliefs in the cross section of the material. The configuration is the same as utilising a conical spring, with the elastomer received into a retainer 27 and is held in position by a sleeve 71 and circlip 57. Again, for clarity purposes the analogue switching arrangement has not been presented in FIG. 9b and a lower housing in the form of a cover 33 is schematically represented.

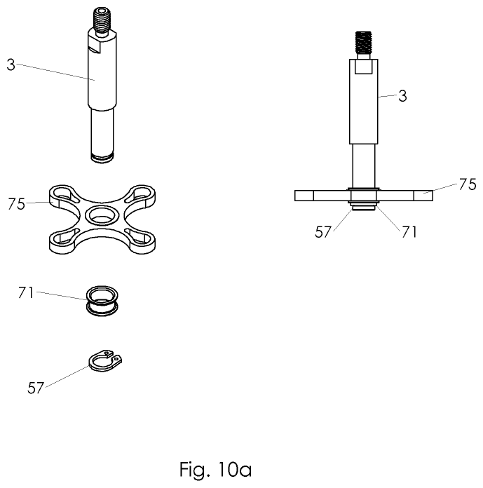

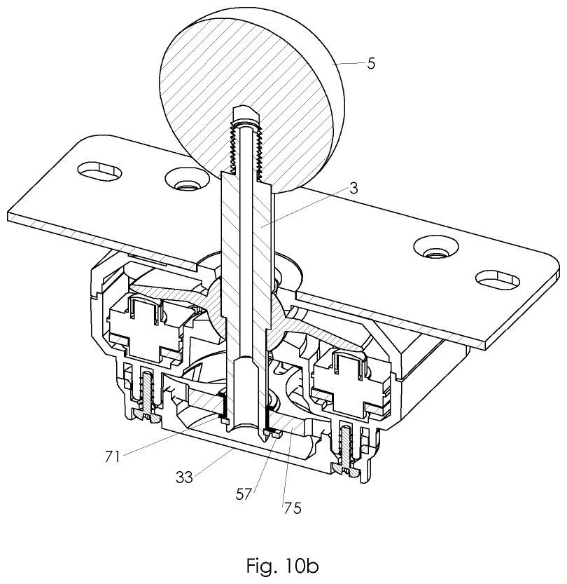

A further alternative configuration as presented in FIG. 10a (exploded view and assembled view respectively) where the biasing arrangement comprises an alternative elastomer for modifying the feel of the joystick. FIG. 10b shows tensioner 75 in an operational configuration in the joystick. The tensioner 75 is pre-tensioned on a bonded sleeve 71 and will provide an equal tensile force in all directions, thus ensuring that when the joystick input 3 is released, the input returns to a central and vertical orientation. As the limbs of the tensioner work in a tensile order, this will provide a sensation of quicker response in directional change, without the resistive feel of relieving the pressure on more regularly shaped circular elastomers. Again, for clarity purposes the analogue switching arrangement has not been presented in FIG. 10b and a lower housing in the form of a cover 33 is schematically represented.

In each of the embodiments presented in FIGS. 10a-c a further component may be included to contain either the spring 23 or an elastomer bush in a common housing of a proportion and form where it can be easily removed or replaced as a module. The module may occupy the central void in the housing about the distal end of the input shaft 3, enabling a quick changeover of the biasing arrangement, to enable certain game players the opportunity to optimise their reactions to meet the various characteristics of different gameplay.

Aspects of the present invention have been described by way of example only and it will be appreciated to the skilled addressee that modifications and variations may be made without departing from the scope of protection afforded by the appended claims.

1. A joystick comprising:
a lever mounted to a base by a pivot, the base having one or more position sensors for sensing a position of the lever relative to the base, the lever having a longitudinal length extending between the pivot and a distal end; and
an input shaft pivotally mounted to a support, the input shaft having a longitudinal length extending between a first end having an input portion for receiving a user input and a second end, the second end cooperating with the distal end of the lever such that pivoting of the input shaft relative to the support causes pivoting of the lever relative to the base.

2. The joystick according to claim 1 arranged such that as the lever is biased from a rest to a displaced configuration the one or more position sensors sense a displaced position of the lever relative to the base through the biasing of the input shaft from a rest configuration to a displaced configuration.

3. The joystick according to claim 1, wherein the longitudinal length of the input shaft is greater than the longitudinal length of the lever.

4. The joystick according to claim 1, wherein the input shaft pivots relative to the support at a position vertically above the pivot about which the lever pivots relative to the base.

5. The joystick according to claim 1, wherein the pivot enables pivoting in a pivot plane about multiple pivot axes.

6. The joystick according to claim 1, wherein one of the distal end and second end of the lever and input shaft respectively receives the other of the distal end and second end into a receiving zone therein.

7. The joystick according to claim 6, wherein the receiving zone projects lengthwise into the input shaft or lever, and the distal end or second end is moveable longitudinally through the receiving zone.

8. The joystick according to claim 7, wherein either the distal end or second end comprises at least a partial sphere.

9. The joystick according to claim 8, wherein the receiving zone comprises a width arranged to receive the sphere such that the sphere contacts opposite sides of the receiving zone.

10. The joystick according to claim 1, wherein the one or more position sensors are configured to measure an analogue output.

11. The joystick according to claim 1, further comprising a plurality of switches arranged such that as the input shaft is biased from a rest position to a displaced position, the input shaft engages with at least one of the plurality of switches to effect activation of at least one of the plurality of switches.

12. The joystick according to claim 11, wherein the input shaft comprises a flange projecting transversely from the longitudinal length for activation of the plurality of switches.

13. The joystick according to claim 11, wherein the plurality of switches are each disposed around the input shaft.

14. The joystick according to claim 12, where there is vertical activation of the switches by the flange.

15. The joystick according to claim 11, wherein the plurality of switches are each disposed intermediate the support and the input shaft.

16. The joystick according to claim 1, wherein the input shaft extends through the support.

17. The joystick according to claim 1, wherein the input shaft and support cooperate by a ball and socket joint.

18. The joystick according to claim 1, wherein the one or more position sensors sense displacement of the lever relative to the base from a rest position to a displaced position, the joystick further comprising a biasing arrangement for biasing the input shaft toward a position for retaining the lever in the rest position.

19. The joystick according to claim 18, wherein the biasing arrangement is arranged to bias the input shaft toward a position whereby the input shaft and lever are axially aligned.

20. The joystick according to claim 18, wherein the biasing arrangement comprises a conical spring.

21. The joystick according to claim 20, wherein a diameter of the conical spring increases in a first direction from the second end towards the first end.

22. The joystick according to claim 18, wherein the biasing arrangement comprises an elastomeric bushing.

23. The joystick according to claim 18, wherein the joystick comprises a first and second housing portion, where the first and second housing portion are releasably mountable to one another and cooperate to define a receiving zone for the biasing arrangement.
